(19) United States
(12) Patent Application Publication
(10) Pub. No.: US 2026/0002524 A1
(43) Pub. Date: Jan. 1, 2026

(54) An Air-Breathing Photoelectric Ion Thruster

(71) Applicant: Aerhart, LLC, Malibu, CA (US)

(72) Inventor: Kevin Burns, Malibu, CA (US)

(73) Assignee: Aerhart, LLC, Malibu, CA (US)

(21) Appl. No.: 18/648,359

(22) Filed: Apr. 27, 2024

Related U.S. Application Data
(60) Provisional application No. 63/501,688, filed on May 12, 2023.

(51) Int. Cl. F03H 1/00; B64D 27/02

(52) U.S. Cl. CPC F03H 1/0037; B64D 27/02

(57) ABSTRACT

Ion thrusters in the prior art apply a high electric potential between an emitter and a collector. Electrons are liberated to form ions around the emitter which are attracted toward the collector. The ions collide with molecules in an atmosphere creating an ionic wind. The electric field both liberates the electrons and attracts the ions to the collector. The disclosed ion thruster decouples the liberation of electrons from the attraction of the ions toward the collector. Instead of liberating the electrons by a coronal discharge, electrons are liberated by the photoelectric effect by shining a light on to the emitter comprised of a low work function solid that is susceptible to allowing electrons to be released. In some embodiments in which the material is easily oxidized, a coating is applied to the surface that allows subatomic particles to pass through the coating while blocking atoms and molecules.

### FIELD

The present disclosure relates to a propulsion system powered by an air-breathing photoelectric ion thruster.

### BACKGROUND

Ion propulsion is presently used in space maneuvering applications, i.e., in a vacuum. Ion propulsion, in earth's atmosphere, offers an alternative to fans (turbofans, propellers, etc.) for accelerating air to generate thrust. Ion thrusters do not require moving parts, thereby increasing simplicity and reliability. Because of this, the possibility exists for less energy to be lost to noise and heat and allowing for quieter and potentially more efficient operation. However, due to their low thrust and low efficiency when using conventional methods of ionization, ion thrusters have not been adopted commercially as a suitable alternative to fans for propulsion purposes.

Conventional air-breathing ion thrusters act by generating a strong electric field between a sharp/thin electrode, called the emitter, and a round/smooth electrode, called the collector. The emitter, such as a point or wire, concentrates the electric field allowing for ionization through coronal discharge. The ions are then attracted towards the collector, such as a rod or plate, colliding with neutral air molecules along the way producing what is known as an ionic wind. Such an ion thruster is characterized by high voltage and low current. If the voltage is raised above the breakdown voltage of the medium, a spark occurs. Thus, there exists an upper bound beyond which the thruster no longer operates. Similarly, there is a lower bound at which point the voltage is unable to produce a coronal discharge. Importantly, the same electric field used to generate ions, also accelerates those ions from the emitter to the collector. This dual-purpose electric field means that the voltage used for accelerating ions must be at least as high as that necessary for coronal discharge. When ions in the air are subjected to an electric field, they are accelerated. And when these ions collide with neutral ones, they transfer part of their momentum, leading to air movement known as an ionic wind. The problem with such an approach is that the high electric field required to generate the ions leads to low system efficiency.

A VTOL (vertical take-off and landing) unmanned vehicle for use in Earth's atmosphere is disclosed in patent publication WO2022086667A2. The problem being solved is unacceptably high noise levels of conventional drones using propellers for propulsion in urban environments. The solution uses the well-known asymmetrical electrodes with high voltage applied thereto to produce the ionic wind. The high voltage is used to generate the ions and also to attract the ions so that they move in a particular direction to generate the ionic wind. The disadvantages of low efficiency by such an approach are not addressed in the WO2022086667A2 reference.

A propulsion system that generates an ionic wind yet is more efficient than prior art such as described in WO2022086667A2, is desired.

### SUMMARY

To overcome at least one of the disadvantages in the prior art, an ion thruster is disclosed which decouples the two processes for creating an ionic wind. Instead of generating a high electric field to create ions around an emitter, a light source is directed onto the emitter to release electrons. An electric field is used to cause ions, created by collisions of the electrons with atmospheric gases, to move in the desired direction. The electric field that leads to the ionic wind is weaker than what is required to create ions through corona discharge.

An ion thruster is disclosed that has a gaseous atmosphere, an emitter disposed within the atmosphere, a light source directed toward the emitter, a collector disposed within the atmosphere and displaced from the emitter, and a voltage source electrically coupled between the emitter and the collector. The collector is at a positive electric potential relative to the emitter. The emitter is comprised of a low work function solid.

The light source directs photons onto the emitter, such photons having energy at least as high as the work function of the emitter.

In some embodiments, the ion thruster has a coating applied to the emitter, such coating allowing subatomic particles to pass through the coating while blocking atoms and molecules from passing through. Example coatings include graphene and graphene-oxide.

The emitter is divided into sections with a substantially nonconductive material disposed between the sections.

The sections of the emitter that are located farther from the collector are at a more negative electric potential relative to the collector than the sections of the emitter that are located closer to the collector.

In some embodiments, resistors are electrically coupled between sections of the emitter. In other embodiments, voltage multipliers are electrically coupled between sections of the emitter.

In some embodiments, the resistors are light sources.

The emitter material may be cesium based.

The voltage applied by the voltage source between the emitter and the collector is less than the voltage at which a coronal discharge occurs.

An aeronautical apparatus for use in a gaseous atmosphere is disclosed. The aeronautical apparatus includes: an emitter comprised of a low work function solid coupled to a component of the aeronautical apparatus, a collector coupled to the component of the aeronautical apparatus, and a voltage source electrically coupled between the emitter and the collector with the collector at a positive electric potential relative to the emitter. The voltage applied by the voltage source between the emitter and the collector is less than the voltage at which a coronal discharge occurs.

In some embodiments, the aeronautical apparatus also includes an ultraviolet light source directed toward the emitter.

The emitter and the collector are affixed to an outer surface of the aeronautical apparatus with the emitter being located closer to an upstream portion of the outer surface than the collector. The outer surface may be: a wing, a fuselage, a stabilizer surface, or a control surface.

In some embodiments, the aeronautical apparatus has a nacelle. The emitter and the collector are affixed to an inner surface of the nacelle with the emitter being located closer to an upstream portion of the nacelle than the collector. The light source is located within the nacelle.

In some embodiments, a coating is applied to the emitter, such coating allowing subatomic particles to pass through the coating while blocking atoms and molecules from passing through.

The emitter is divided into sections and a substantially nonconductive material is disposed between the sections. Conductors are provided to electrically couple adjacent sections of the emitter. The conductors are one of: resistors, light sources, and voltage multipliers.

In some embodiments, the light source is the sun.

Some embodiments include a conductive element disposed on the component of the aeronautical apparatus. The conductive element is located farther from the collector than the emitter. The conductive element is made from a solid that has a higher work function than the emitter.

### BRIEF DESCRIPTION OF THE DRAWINGS

FIG. 1 is an illustration of a prior-art ion thruster;

FIG. 2 is an aeronautical apparatus with wings that includes an embodiment of an ion thruster;

FIGS. 3 and 4 show illustrations of ion thrusters according to embodiments of the present disclosure;

FIG. 5 is an atomic view of a coating to protect the surface of an emitter of the ion thruster;

FIG. 6 is a portion of a wing having a collector, sections of emitters, and a plurality of lights;

FIGS. 7 and 8 are ion thrusters having non-flat configurations;

FIGS. 9 and 10 show ion thruster configurations which provides different voltage levels to each of the emitter sections; and

FIG. 11 shows an alternative where the emitter has a lower surface area, and the light source is of higher intensity.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations, whether or not explicitly described or illustrated.

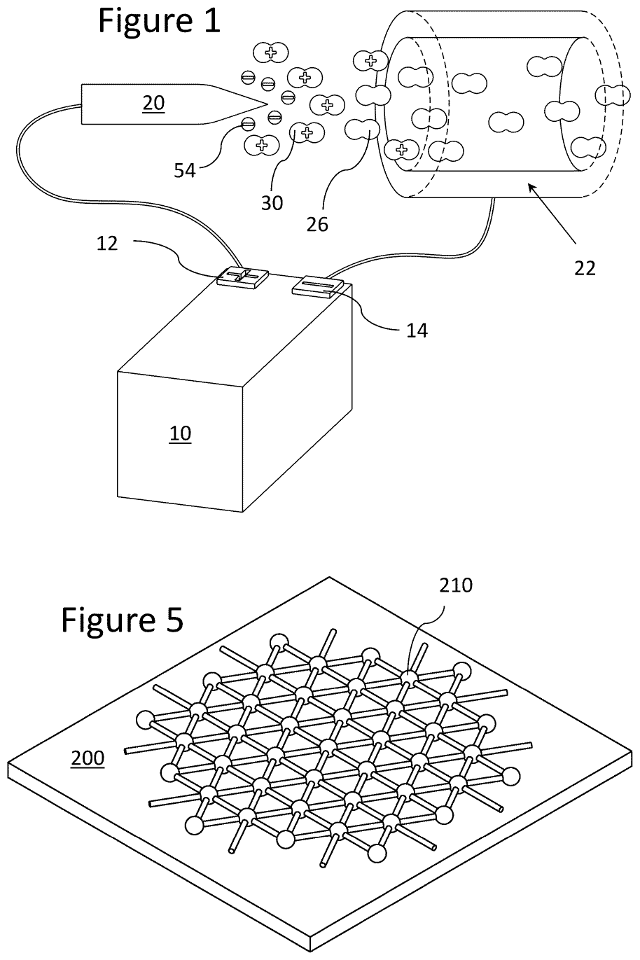

In FIG. 1, an ion thruster is shown that has a battery 10 with a positive terminal 12 and a negative terminal 14. Positive terminal 12 is electrically coupled to an emitter 20 and negative terminal 14 is electrically coupled to a collector 22. Due to the emitter 20 having a pointed end, the electric field is more concentrated around the emitter. The concentrated electric field causes positive ions 30 to develop by the emitter 20 that are repelled by emitter 20 and attracted to collector 22. The net movement is in the direction from emitter 20 to collector 22. Moving positive ions 30 collide with neutral molecules 26 (such as oxygen and nitrogen of air) and pushes them toward collector 22. Electrons 54 are shown close to the emitter, having been pulled from neutral air molecules 26 to form positive ions 30. FIG. 1 shows emitter 20 to be connected to positive terminal 12. Alternatively, the polarity can be reversed, in which case negative ions are generated and are attracted towards the collector, which in this case is positively charged. The setup in FIG. 1 is prior art and suffers from low efficiency due to the strong electric field that is necessary to cause the corona discharge.

According to an aspect of the present disclosure, the electric field at the emitter is weaker, which does not lead to a corona discharge. Instead, to release electrons from the emitter, the well-known photoelectric effect is used. The photoelectric effect is the phenomenon in which electrons are released from a material when electromagnetic radiation is directed onto the surface of the material. The efficiency of the release of charged particles, sometimes called quantum efficiency, is improved when the material has low work function.

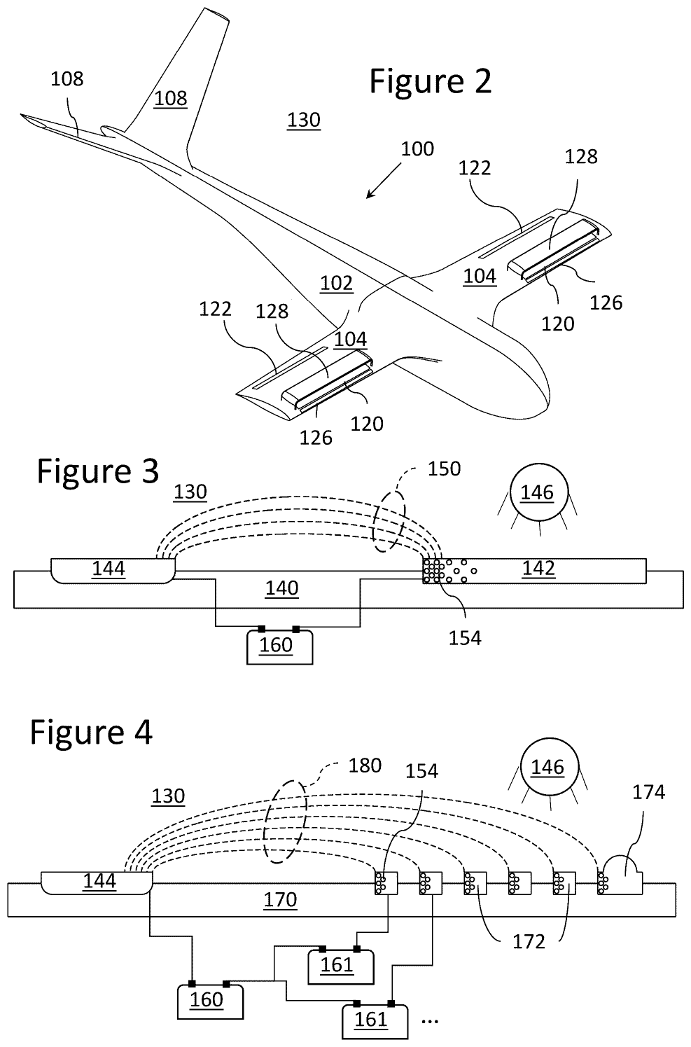

An aeronautical apparatus 100 is shown in FIG. 2. Aeronautical apparatus 100 has a fuselage 102, wings 104, and stabilizers 108. Emitters 120 and collectors 122 are affixed to wings 104. The ionic wind developed by emitter 120 and collector 122 travels toward the aft to propel aeronautical apparatus 100. Alternatively, emitters 120 and collectors 122 can be affixed to other components such as, but not limited to, fuselage 102 and stabilizers 108. Aeronautical apparatus 100 is intended for use in the earth's atmosphere, 130. Aeronautical apparatuses having other shapes may employ the propulsion system described herein for travel through other media.

In FIG. 3, a cross-sectional illustration of an ion thruster with an emitter 142 and a collector 144 affixed to a component 140 is shown. A voltage source 160, such as a battery, is electrically coupled between collector 144 and emitter 142. An electric field 150, illustrated as dashed lines, is developed between collector 144 and emitter 142. Electrons 154 congregate at the edge of emitter 142 nearest collector 144. A light source 146 directs photons on emitter 142. It has been found experimentally that such a configuration was inefficient because many of the electrons are traveling through emitter 142 to the edge nearest the collector 144 rather than through the atmosphere.

An alternative is shown in FIG. 4, in which an emitter 172 is broken up into sections connected to a voltage source 161 (only two voltage sources 161 and two sets of electric couplings are shown for the five sections illustrated in FIG. 4 for clarity). A base 170 into which emitter 172 is contained is made of an insulating material so that electrons 154, although congregating at the edge of each emitter 172 section, allow for more sections from which electrons are removed into the atmosphere. Note how lines of electric field 180 extend over the emitter 172 in FIG. 4 compared to emitter 142 in FIG. 3 where the electric field is more compressed. The configuration in FIG. 4 was shown, experimentally, to provide a greater thrust. Each section of emitter 172 is electrically coupled to the same pole of corresponding voltage source 161 with the other poles being electrically coupled together to a common electric coupling such as a common ground. A voltage source 160 is electrically coupled to the common electric coupling by its opposite pole than voltage source 161, with the other pole being electrically coupled to a collector 144.

Yet another improvement of the configuration in FIG. 4 compared to that in FIG. 3 is having an upstream section 174. Upstream sections 126 are shown on wings 104 of aeronautical apparatus 100 in FIG. 1. Referring back to FIG. 4, upstream section 174 is made from a high work function solid, i.e., one which is not susceptible to the photoelectric effect to remove electrons, meaning electrons are not prone to escape from the surface. However, the electric field associated with upstream section 174 helps to restrain the electrons that have been released from the surface of emitter 172 to stay within the desired space.

Most materials that have a low work function oxidize readily. In embodiments in the earth's atmosphere, this can present an issue because the surface of the emitter can become oxidized. Then, even though the base material has a low work function, the surface no longer has a low work function and the ability to generate an ion wind is lessened. In some embodiments a coating is applied to the surface of the emitter which allows photons and electrons to pass through the coating while preventing the much larger oxygen molecules from accessing the surface. One such possible coating is graphene 210, shown in an atomic representation in FIG. 5. Graphene is an allotrope of carbon consisting of a single layer of atoms arranged in a hexagonal lattice nanostructure shown on the surface of an emitter 200. An alternative material which is in a single layer of atoms is graphene oxide which is the oxidized form of graphene. Any material that provides the desired properties of allowing electrons to leave the material while preventing molecules from accessing the surface is suitable for covering the emitter surface. Many layers of the material may be desired to coat the surface more effectively while still allowing passage of photons and electrons.

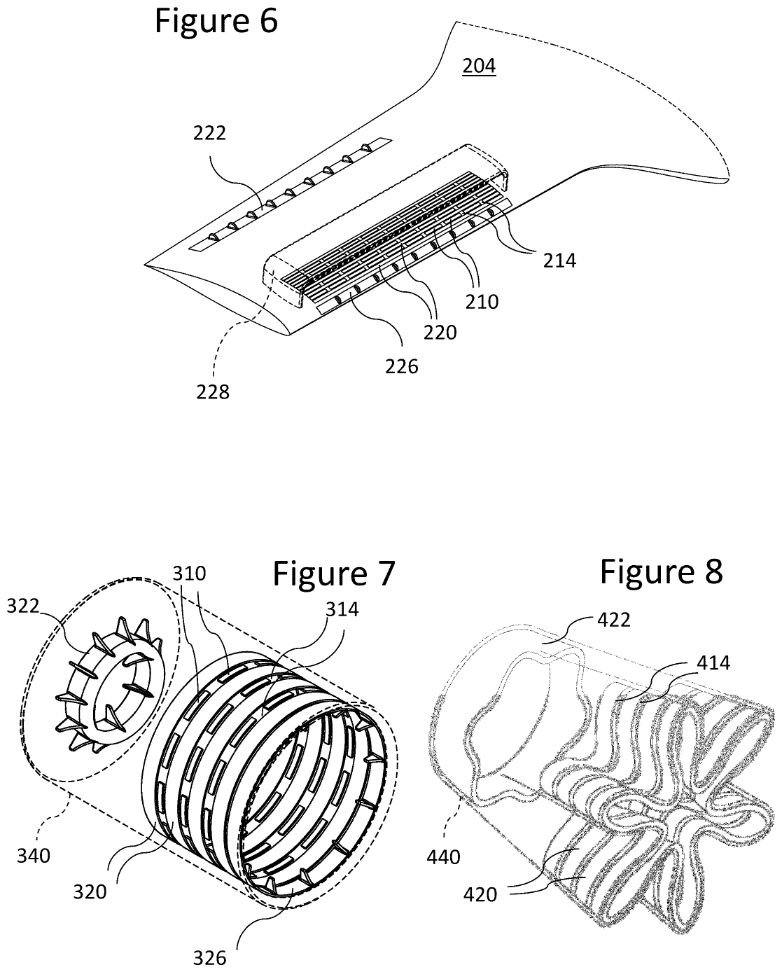

Referring to FIG. 2, covers 128 are provided on each of wings 104. Covers 128 have light sources in them to direct light of an appropriate wavelength onto emitters 120. It is anticipated that such a configuration may be insufficient to provide the desired thrust. A configuration is shown in FIG. 6 in which a portion of a wing 204 is shown with a collector 222 on the aft of wing 204. Collector 222 has fins disposed between sections of collector 222. An upstream section 226 is provided on the fore of wing 204, also shown with fins. Emitter 220 is made up a plurality of parallel strips of a material with a low work function (only two of them are provided with leader lines in FIG. 6). Between each parallel strip of emitter 220 are parallel strips of an electrically insulating material 214 with a plurality of lights 210 (illustrated as rectangular blocks) in each strip of insulating material 214. A cover 228 is shown in phantom extending over emitter 220. The underside of cover 228 also includes a plurality of strips making up an emitter and a plurality of insulating materials and lights (not illustrated in FIG. 6), which is similar to emitter 220, insulating material 214, and lights 210 as shown on wing 204. To provide even more thrust, additional levels of emitters and lights can be used, for example with emitter 220, insulating material 214, and lights 210 on the top of cover 228 with then an additional cover over cover 228.

Alternative shapes, such as those shown in FIGS. 7 and 8 are also possible. In FIG. 7, a nacelle 340 shown in phantom (which is commonly attached to a wing) includes an emitter 320 that are rings with electrically insulating material rings 314 between adjacent rings of emitter 320. Lights 310 are disposed on insulating rings 314. A collector 322 is at the aft portion of nacelle 340 and an upstream section 326 is at the forward portion. Additional thrust would be possible with concentric emitters in another alternative. In FIG. 8, a nacelle 440, shown in phantom, has a collector 422, emitter strips 420 and insulating rings 414. Not shown are lights yet would also be included within nacelle 440.

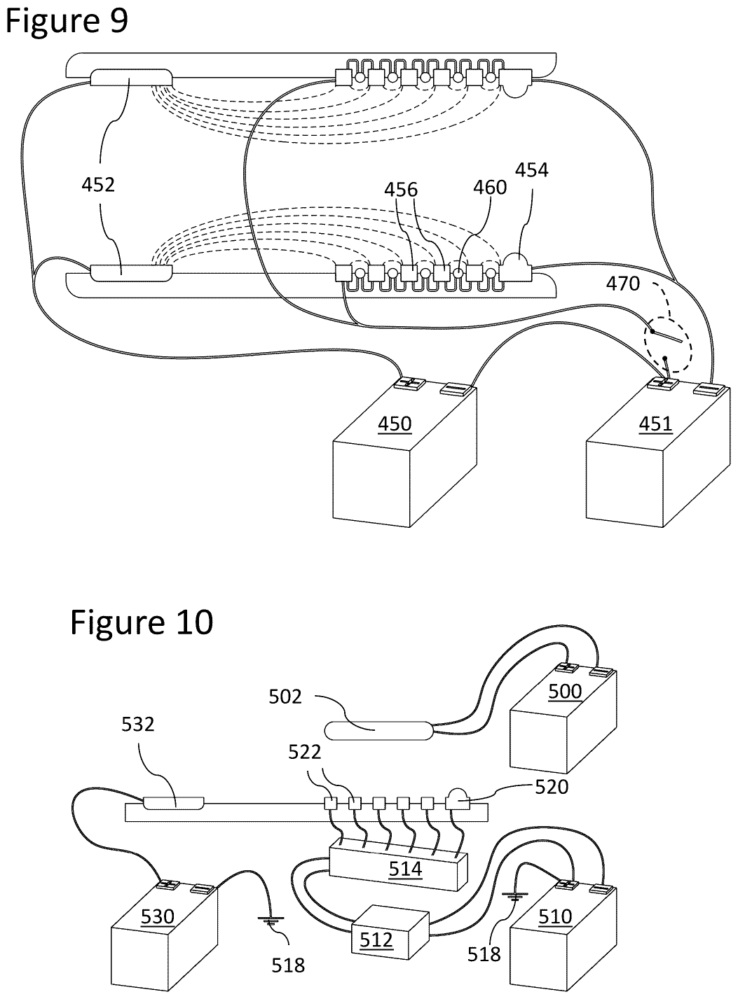

In some embodiments, the voltage between the collector and strips of the emitter is of higher magnitude for the strips that are farther from the collector. Such an embodiment is shown in FIG. 9. A battery 450 is electrically coupled between collectors 452 and battery 451. Battery 451 is electrically coupled between battery 450 and upstream sections 454. Upstream section 454 is electrically coupled to an emitter section 456 (the rightmost emitter section in FIG. 9, i.e., the emitter section that is farthest from collector 452) via a light 460. Between adjacent emitter sections 456 light 460 is electrically coupled. Light 460 presents a voltage drop so that the voltage between the collector 452 and each emitter section 456 is slightly reduced from right to left in the configuration in FIG. 9. A switch 470 exists between an emitter section 456 (the leftmost emitter section in FIG. 9, i.e., the emitter section that is closest to collector 452) and the common potential between battery 450 and battery 451. When switch 470 is closed, a circuit is completed allowing electric current to flow, turning on lights 460 and creating the voltage difference between emitter sections 456. Once lights 460 are on, a second circuit is completed due to electrons being released from the emitter sections 456 and flowing towards collector 452. If the electric current due to the second circuit is enough to sustain the operation of lights 460, then switch 470 can be opened.

Another alternative for providing lower voltage magnitudes between the collector and the emitter sections closer to the collector uses a voltage multiplier, which is well-known in the prior art. In FIG. 10, a stand-alone battery 500 powers a light source 502. The emitter sections 522 and upstream section 520 are electrically coupled to a voltage multiplier 514, which in turn is electronically coupled to an inverter 512, which is in turn electrically coupled to a battery 510. The positive pole of battery 510 is electrically coupled to ground 518. Another battery 530 is electrically coupled between ground 518 and a collector 532.

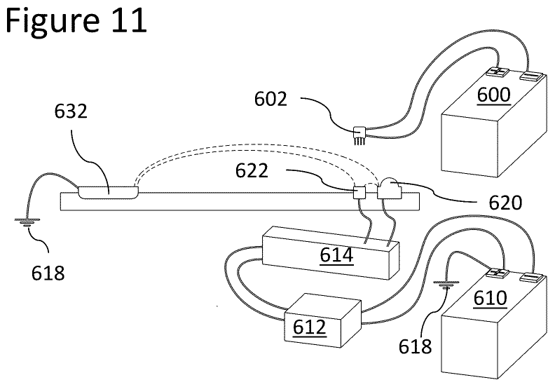

The number of electrons released from a surface due to the photoelectric electric effect, sometimes called the photoelectric current, is a function of the number of photons of an appropriate wavelength incident upon a surface. One way to increase the number of photons that reach the surface is to increase the surface area. An alternative is to increase the intensity of the light on the surface such as by a focused beam or laser which would allow the surface area to be relatively small while still being able to produce a high photoelectric current. In FIG. 11, a stand-alone battery 600 powers a high-intensity light source 602. The emitter 622 and upstream section 620 are electrically coupled to a voltage multiplier 614, which in turn is electronically coupled to an inverter 612, which is in turn electrically coupled to a battery 610. The positive pole of battery 610 is electrically coupled to ground 618. Collector 632 is electrically coupled to ground 618. High-intensity light source 602 directs high-intensity light of an appropriate wavelength onto the surface of emitter 622.

While the best configuration has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, efficiency, strength, durability, life cycle cost, marketability, speed, endurance, range, appearance, packaging, size, serviceability, weight, manufacturability, ease of assembly, etc. The embodiments described herein that are characterized as less desirable than other embodiments or prior-art implementations with respect to one or more characteristics are not outside the scope of the disclosure and may be desirable for particular applications.

I claim:

1. An ion thruster, comprising:
a gaseous atmosphere;
an emitter disposed within the atmosphere;
a light source directed toward the emitter;
a collector disposed within the atmosphere and displaced from the emitter; and
a voltage source electrically coupled between the emitter and the collector;
wherein:
the collector is at a positive electric potential relative to the emitter; and
the emitter is comprised of a low work function solid.

2. The ion thruster of claim 1 wherein the light source directs photons onto the emitter, such photons having energy at least as high as the work function of the emitter.

3. The ion thruster of claim 1, further comprising: a coating applied to the emitter, such coating allowing subatomic particles to pass through the coating while blocking atoms and molecules from passing through.

4. The ion thruster of claim 3 wherein the coating is comprised of one of: graphene and graphene-oxide.

5. The ion thruster of claim 1 wherein:
the emitter is divided into sections; and
a substantially nonconductive material is disposed between the sections.

6. The ion thruster of claim 5 wherein:
the sections of the emitter that are located farther from the collector are at a more negative electric potential relative to the collector than the sections of the emitter that are located closer to the collector.

7. The ion thruster of claim 6 further comprising:
one of: resistors and voltage multipliers electrically coupled between sections of the emitter.

8. The ion thruster of claim 7 wherein the resistors are light sources.

9. The ion thruster of claim 1 wherein the emitter material is cesium based.

10. The ion thruster of claim 1 wherein the voltage applied by the voltage source between the emitter and the collector is less than the voltage at which a coronal discharge occurs.

11. An aeronautical apparatus for use in a gaseous atmosphere, comprising:
an emitter comprised of a low work function solid coupled to a component of the aeronautical apparatus;
a collector coupled to the component of the aeronautical apparatus; and
a voltage source electrically coupled between the emitter and the collector with the collector at a positive electric potential relative to the emitter, wherein the voltage applied by the voltage source between the emitter and the collector is less than the voltage at which a coronal discharge occurs.

12. The aeronautical apparatus of claim 11, further comprising: an ultraviolet light source directed toward the emitter.

13. The aeronautical apparatus of claim 11, wherein:
the aeronautical apparatus has an outer surface; and
the emitter and the collector are affixed to the outer surface with the emitter being located closer to an upstream portion of the outer surface than the collector, wherein the outer surface is one of: a wing, a fuselage, a stabilizer surface, and a control surface.

14. The aeronautical apparatus of claim 12, further comprising:
a nacelle, wherein:
the emitter and the collector are affixed to an inner surface of the nacelle with the emitter being located closer to an upstream portion of the nacelle than the collector; and
the light source is located within the nacelle.

15. The aeronautical apparatus of claim 11, further comprising: a coating applied to the emitter, such coating allowing subatomic particles to pass through the coating while blocking atoms and molecules from passing through.

16. The aeronautical apparatus of claim 11, wherein:
the emitter is divided into sections; and
a substantially nonconductive material is disposed between the sections.

17. The aeronautical apparatus of claim 16, further comprising:
conductors electrically coupling adjacent sections of the emitter.

18. The aeronautical apparatus of claim 17, wherein the conductors are one of: resistors, light sources, and voltage multipliers.

19. The aeronautical apparatus of claim 12, wherein the light source is the sun.

20. The aeronautical apparatus of claim 11, further comprising:
a conductive element disposed on the component of the aeronautical apparatus wherein:
the conductive element is located farther from the collector than the emitter; and
the conductive element is made from a solid that has a higher work function than the emitter.
